(19) United States
(12) Patent Application Publication
(10) Pub. No.: US 2024/0414635 A1
(43) Pub. Date: Dec. 12, 2024

(54) CONFIGURING A DEVICE BASED ON MULTIPLE SEARCH SPACE SETS

(71) Applicant: Lenovo (Singapore) Pte. Ltd., New Tech Park (SG)

(72) Inventors: Ankit Bhamri, Rödermark (DE); Alexander Golitschek Edler von Elbwart, Darmstadt (DE); Joachim Löhr, Wiesbaden (DE); Karthikeyan Ganesan, Kronberg im Taunus (DE); Ali Ramadan Ali, Kraiburg am Inn (DE); Prateek Basu Mallick, Dreieich (DE)

(21) Appl. No.: 18/697,135

(22) PCT Filed: Sep. 30, 2022
(86) PCT No.: PCT/IB2022/059361

§ 371 Date: Mar. 29, 2024

Related U.S. Application Data
(60) Provisional application No. 63/250,745, filed on Sep. 30, 2021.

(51) Int. Cl. H04W 48/12; H04W 72/0446; H04W 72/232

(52) U.S. Cl. CPC H04W 48/12; H04W 72/0446; H04W 72/232

(57) ABSTRACT

Apparatuses, methods, and systems are disclosed for configuring a device based on multiple search space sets. One method includes receiving, at a user equipment (“UE”), a configuration from a network for UE-specific search space (“USS”) sets and common search space (“CSS”) sets. The method includes receiving control information associated with the CSS sets in the USS sets in response to the CSS sets being configured outside of monitoring occasions of the UE and the USS sets are configured within physical downlink control channel (“PDCCH”) monitoring occasions of the UE.

### CROSS-REFERENCE TO RELATED APPLICATIONS

This application claims priority to U.S. Patent Application Ser. No. 63/250,745 entitled “APPARATUSES, METHODS, AND SYSTEMS FOR USS AND CSS ALIGNMENT FOR MULTI-SLOT PDCCH MONITORING” and filed on Sep. 30, 2021 for Ankit Bhamri et al., which is incorporated herein by reference in its entirety.

### FIELD

The subject matter disclosed herein relates generally to wireless communications and more particularly relates to configuring a device based on multiple search space sets.

### BACKGROUND

In certain wireless communications systems, multiple search space sets may be used. Each search space set may correspond to a particular time period.

### BRIEF SUMMARY

Methods for configuring a device based on multiple search space sets are disclosed. Apparatuses and systems also perform the functions of the methods. One embodiment of a method includes receiving, at a user equipment (“UE”), a configuration from a network for UE-specific search space (“USS”) sets and common search space (“CSS”) sets. In some embodiments, the method includes receiving control information associated with the CSS sets in the USS sets in response to the CSS sets being configured outside of monitoring occasions of the UE and the USS sets are configured within physical downlink control channel (“PDCCH”) monitoring occasions of the UE.

One apparatus for configuring a device based on multiple search space sets includes a receiver to: receive a configuration from a network for USS sets and CSS sets; and receive control information associated with the CSS sets in the USS sets in response to the CSS sets being configured outside of monitoring occasions of the apparatus and the USS sets are configured within PDCCH monitoring occasions of the apparatus.

Another embodiment of a method for configuring a device based on multiple search space sets includes receiving, at a UE, a configuration from a network for USS sets and CSS sets. The USS sets and the CSS sets are configured to be non-overlapping in time within a slot group. In some embodiments, the method includes determining an overall blind decoding budget for monitoring a configured USS and a configured CSS and, in response to a total required budget being greater than a UE reported capability for the slot group, prioritizing the overall blind decoding budget for the configured CSS and a remaining budget for the configured USS.

Another apparatus for configuring a device based on multiple search space sets includes a receiver to receive a configuration from a network for USS sets and CSS sets. The USS sets and the CSS sets are configured to be non-overlapping in time within a slot group. In some embodiments, the apparatus includes a processor to determine an overall blind decoding budget for monitoring a configured USS and a configured CSS and, in response to a total required budget being greater than a UE reported capability for the slot group, prioritize the overall blind decoding budget for the configured CSS and a remaining budget for the configured USS.

A further embodiment of a method for configuring a device based on multiple search space sets includes receiving, at a UE, a configuration from a network for USS sets and CSS sets. Only the CSS sets are configured within a slot group, and the CSS sets are outside of PDCCH monitoring occasions within a slot group. In some embodiments, the method includes applying an offset to shift starting of the slot group of the PDCCH monitoring occasion so that the CSS sets are aligned and fall within the PDCCH monitoring occasions.

A further apparatus for configuring a device based on multiple search space sets includes a receiver to receive a configuration from a network for USS sets and CSS sets. Only the CSS sets are configured within a slot group, and the CSS sets are outside of PDCCH monitoring occasions within a slot group. In some embodiments, the apparatus includes a processor to apply an offset to shift starting of the slot group of the PDCCH monitoring occasion so that the CSS sets are aligned and fall within the PDCCH monitoring occasions.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring a device based on multiple search space sets;

FIG. 2 is a schematic block diagram illustrating one embodiment of an apparatus that may be used for configuring a device based on multiple search space sets:

FIG. 3 is a schematic block diagram illustrating one embodiment of an apparatus that may be used for configuring a device based on multiple search space sets:

FIG. 4 is a schematic block diagram illustrating one embodiment of a system for monitoring CSS associated information in USS and not monitoring CSS:

FIG. 5 is a schematic block diagram illustrating one embodiment of a system for monitoring CSS and USS in separate PDCCH MOs within a slot group:

FIG. 6 is a schematic block diagram illustrating one embodiment of a system for shifting PDCCH MOs to align with CSS:

FIG. 7 is a flow chart diagram illustrating one embodiment of a method for configuring a device based on multiple search space sets:

FIG. 8 is a flow chart diagram illustrating another embodiment of a method for configuring a device based on multiple search space sets; and

FIG. 9 is a flow chart diagram illustrating a further embodiment of a method for configuring a device based on multiple search space sets.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

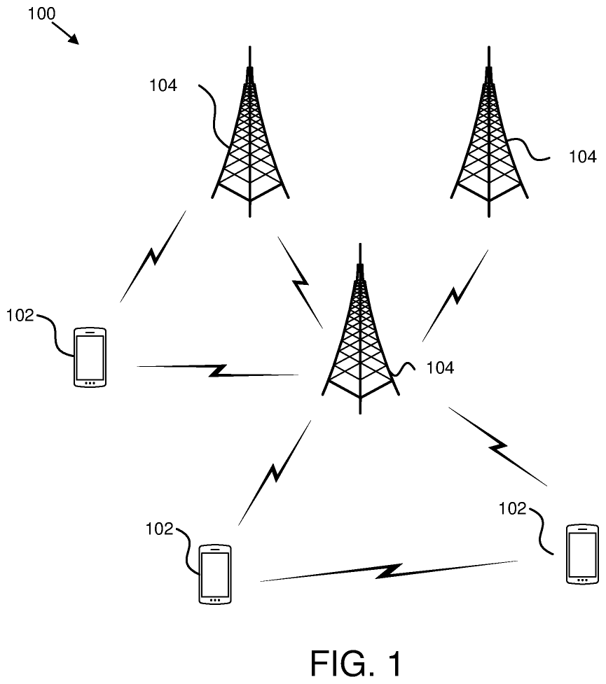

FIG. 1 depicts an embodiment of a wireless communication system 100 for configuring a device based on multiple search space sets. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth R, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a configuration from a network for USS sets and CSS sets. In some embodiments, the remote unit 102 may receive control information associated with the CSS sets in the USS sets in response to the CSS sets being configured outside of monitoring occasions of the UE and the USS sets are configured within PDCCH monitoring occasions of the UE. Accordingly, the remote unit 102 may be used for configuring a device based on multiple search space sets.

In certain embodiments, a remote unit 102 may receive a configuration from a network for USS sets and CSS sets. The USS sets and the CSS sets are configured to be non-overlapping in time within a slot group. In some embodiments, the remote unit 102 may determine an overall blind decoding budget for monitoring a configured USS and a configured CSS and, in response to a total required budget being greater than a UE reported capability for the slot group, prioritizing the overall blind decoding budget for the configured CSS and a remaining budget for the configured USS. Accordingly, the remote unit 102 may be used for configuring a device based on multiple search space sets.

In certain embodiments, a remote unit 102 may receive a configuration from a network for USS sets and CSS sets. Only the CSS sets are configured within a slot group, and the CSS sets are outside of PDCCH monitoring occasions within a slot group. In some embodiments, the remote unit 102 may apply an offset to shift starting of the slot group of the PDCCH monitoring occasion so that the CSS sets are aligned and fall within the PDCCH monitoring occasions. Accordingly, the remote unit 102 may be used for configuring a device based on multiple search space sets.

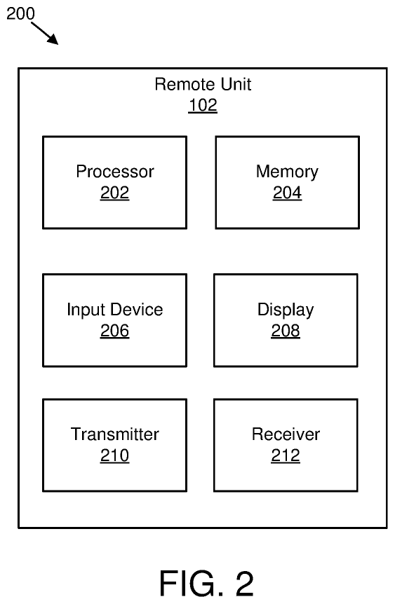

FIG. 2 depicts one embodiment of an apparatus 200 that may be used for configuring a device based on multiple search space sets. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 to: receive a configuration from a network for USS sets and CSS sets; and receive control information associated with the CSS sets in the USS sets in response to the CSS sets being configured outside of monitoring occasions of the apparatus and the USS sets are configured within PDCCH monitoring occasions of the apparatus.

In certain embodiments, the receiver 212 to receive a configuration from a network for USS sets and CSS sets. The USS sets and the CSS sets are configured to be non-overlapping in time within a slot group. In some embodiments, the processor 202 to determine an overall blind decoding budget for monitoring a configured USS and a configured CSS and, in response to a total required budget being greater than a UE reported capability for the slot group, prioritize the overall blind decoding budget for the configured CSS and a remaining budget for the configured USS.

In certain embodiments, the receiver 212 to receive a configuration from a network for USS sets and CSS sets. Only the CSS sets are configured within a slot group, and the CSS sets are outside of PDCCH monitoring occasions within a slot group. In some embodiments, the processor 202 to apply an offset to shift starting of the slot group of the PDCCH monitoring occasion so that the CSS sets are aligned and fall within the PDCCH monitoring occasions.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

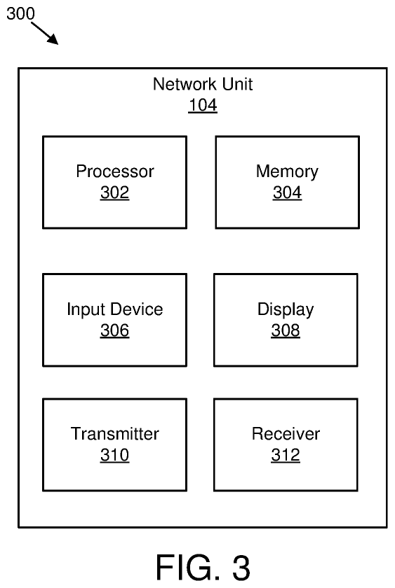

FIG. 3 depicts one embodiment of an apparatus 300 that may be used for configuring a device based on multiple search space sets. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

It should be noted that one or more embodiments described herein may be combined into a single embodiment.

In certain embodiments, such as in new radio (“NR”), for extension of NR operation from 52.6 GHz to 71 GHz, physical layer procedures may support enhancement to physical downlink control channel (“PDCCH”) monitoring, including blind detection and/or control channel element (“CCE”) budget, and multi-slot span monitoring. In such embodiments, there may be potential limitation to user equipment (“UE”) PDCCH configuration and capabilities related to PDCCH monitoring.

In some embodiments, multi-slot PDCCH monitoring is used, and there may be a specific framework for higher subcarrier spacing (“SCS”) such as 480 kHz and 960 kHz. In multi-slot PDCCH monitoring, UE PDCCH monitoring capability is defined for a group of slots rather than a single slot. Furthermore, the exact location and duration within the multiple slots may vary. For each UE, a network may be expected to configure search spaces such that the UE is not required to process beyond a reported UE capability in terms of blind decodes or number of CCEs. For a USS, the network may configure accordingly. However, for CSS, the network may configure the search space such that the CSS falls within the desired monitoring occasions within multiple slots for PDCCH monitoring. There may be a high possibility of misalignment between USS and CSS for UEs within multi-slot PDCCH monitoring. Described herein are solutions to deal with the issue of misalignment of USS and CSS for multi-slot PDCCH monitoring.

In various embodiments, one of the following alternatives for defining the multi-slot PDCCH monitoring capability may be used: 1) use a fixed pattern of slot groups as the baseline to define the new capability, wherein a) each slot group includes X slots, b) slot groups are consecutive and non-overlapping, c) the capability indicates the blind decoding (“BD”) and/or control channel element (“CCE”) budget within Y consecutive symbols or slots in each slot group separately, d) supported values and/or constraints of X and Y may be defined (e.g., Y<=X, Y=X), e) restrictions on location of the Y symbols or slots within a slot group (e.g., the Y symbols or slots always start at the first slot within a slot group), and f) there may be a definition of capabilities: 2) use a span (e.g., X, Y) as the baseline to define a new capability, wherein a) X is the minimum time separation between the start of two consecutive spans, b) the capability indicates the BD and/or CCE budget within a span of at most Y consecutive symbols or slots, c) Y<=X, d) exact values of X and Y and units in which they are defined (e.g., symbols, slots) including cases where a span is longer than one slot or crosses a slot boundary may be defined, e) there may be a span pattern defined and/or supported-if it is supported, it may be determined whether a number of slots within which the span pattern is repeated is needed, and if needed, the value of the number of slots, and f) there may be a further definition of capabilities: 3) use a sliding window of X slots as the baseline to define a new capability, wherein a) the capability indicates the BD and/or CCE budget within the sliding window, b) the sliding unit of the sliding window is 1 slot, and c) there may be a further definition of capabilities; and 4) specific numbers for X and Y may depend on a UE capability and gNB configuration. In one example, X=[4] slots for 480 kHz SCS and X=[8] slots for 960 kHz SCS.

In certain embodiments, for 120 kHz SCS, no multi-slot UE capability for PDCCH monitoring is needed. In some embodiments, for 120 kHz SCS in 52.6-71 GHz, the BD and/or CCE budget is the same as that for 120 kHz in frequency range 2 (“FR2”).

In various embodiments, for reporting the multi-slot PDCCH monitoring capability, at least the following values may be used: 1) X=4 slots for SCS 480 kHz; and 2) X=8 slots for SCS 960 kHz.

In certain embodiments, a fixed pattern of slot groups may be used as the baseline to define a new capability, in which: 1) each slot group includes X slots: 2) slot groups are consecutive and non-overlapping: 3) the capability indicates the BD and/or CCE budget within Y consecutive slots in each slot group separately: 4) there may be down-selection of Y within 1<=Y<=X/2 (e.g., both in units of slot) when X>1:5) there may be supported values and/or constraints of X and Y (e.g., Y<=X, Y=X): 6) restrictions on location of the Y slots within a slot group (e.g., the Y slots always start at the first slot within a slot group): 7) there may be a definition of capabilities; and 8) the UE capability defines for monitoring within the Y slots.

In some embodiments, a fixed pattern of slot groups may be used as the baseline to define a new capability, in which: 1) each slot group includes X slots: 2) slot groups are consecutive and non-overlapping: 3) the capability indicates the BD and/or CCE budget within Y consecutive slots in each slot group separately: 4) the location of the Y slots within the X slots is maintained across different slot groups: 5) there may be down-selection of Y within 1<=Y<=X/2 (e.g., both in units of slot) when X>1:6) there may be restrictions on location of the Y slots within a slot group (e.g., the Y slots always start at the first slot within a slot group); and 7) there may be a further definition of capabilities. In various embodiments, the following issues for a search space configuration may be determined: 1) whether a slot group is aligned with a slot boundary: 2) there may be restrictions on a location of the Y slots within a slot group (e.g., whether to restrict the location of a SS to be within the first Y slots within a slot group; and 3) the UE capability may be defined for monitoring within the Y slots.

In certain embodiments: 1) a UE supporting 480 kHz SCS supports multi-slot PDCCH monitoring for 480 kHz SCS: 2) a UE supporting 960 kHz SCS supports multi-slot PDCCH monitoring for 960 kHz SCS; and 3) it may be determined whether to apply multi-slot PDCCH monitoring at all times and for all search spaces.

In some embodiments, there may be PDCCH monitoring in NR. In such embodiments, a UE procedure for monitoring PDCCH may be defined with a UE procedure for determining PDCCH assignment.

In various embodiments, a set of PDCCH candidates for a UE to monitor is defined in terms of PDCCH search space sets. A search space set may be a CSS set or a USS set. A UE monitors PDCCH candidates in one or more of the following search spaces sets: 1) a Type0-PDCCH CSS set configured by pdcch-ConfigSIB1 in master information block (“MIB”) or by searchSpaceSIB1 in PDCCH-ConfigCommon or by searchSpaceZero in PDCCH-ConfigCommon for a downlink control information (“DCI”) format with cyclic redundancy check (“CRC”) scrambled by a system information (“SI”)-radio network temporary identifier (“RNTI”) (“SI-RNTI”) on the primary cell of the master cell group (“MCG”): 2) a Type0A-PDCCH CSS set configured by searchSpaceOtherSystemInformation in PDCCH-ConfigCommon for a DCI format with CRC scrambled by a SI-RNTI on the primary cell of the MCG: 3) a Type1-PDCCH CSS set configured by ra-SearchSpace in PDCCH-ConfigCommon for a DCI format with CRC scrambled by a random access (“RA”)-RNTI, a MsgB-RNTI, or a temporary (“T”) cell (“C”) (“TC”)-RNTI on the primary cell: 4) a Type2-PDCCH CSS set configured by paging SearchSpace in PDCCH-ConfigCommon for a DCI format with CRC scrambled by a paging (“P”)-RNTI on the primary cell of the MCG: 5) a Type3-PDCCH CSS set configured by SearchSpace in PDCCH-Config with searchSpaceType=common for DCI formats with CRC scrambled by interruption (“INT”)-RNTI, slot format indicator (“SFI”)-RNTI, transmit power control (“TPC”)-PUSCH-RNTI, TPC-PUCCH-RNTI, TPC-SRS-RNTI, or cancellation indicator (“CI”)-RNTI and, only for the primary cell, C-RNTI, modulation coding scheme (“MCS”)-C-RNTI, configured scheduling (“CS”)-RNTI(s), or PS-RNTI; and 6) a USS set configured by SearchSpace in PDCCH-Config with searchSpace Type=ue-Specific for DCI formats with CRC scrambled by C-RNTI, MCS-C-RNTI, SP-CSI-RNTI, CS-RNTI(s), sidelink (“SL”)-RNTI, SL-CS-RNTI, or SL SPS V-RNTI.

In certain embodiments, for a downlink (“DL”) bandwidth part (“BWP”), if a UE is not provided searchSpaceSIB1 for Type0-PDCCH CSS set by PDCCH-ConfigCommon, the UE does not monitor PDCCH candidates for a Type0-PDCCH CSS set on the downlink (“DL”) BWP. The Type0-PDCCH CSS set is defined by the CCE aggregation levels and the number of PDCCH candidates per CCE aggregation level given in Table 1. If the active DL BWP and the initial DL BWP have same SCS and same cyclic prefix (“CP”) length and the active DL BWP includes all resource blocks (“RBs”) of the control resource set (“CORESET”) with index 0, or the active DL BWP is the initial DL BWP, the CORESET configured for Type0-PDCCH CSS set has CORESET index 0 and the Type0-PDCCH CSS set has search space set index 0.

In some embodiments, for a DL BWP, if a UE is not provided searchSpaceOtherSystemInformation for Type0A-PDCCH CSS set, the UE does not monitor PDCCH for Type0A-PDCCH CSS set on the DL BWP. The CCE aggregation levels and the number of PDCCH candidates per CCE aggregation level for Type0A-PDCCH CSS set are given in Table 1.

In various embodiments, for a DL BWP, if a UE is not provided ra-SearchSpace for Type 1-PDCCH CSS set, the UE does not monitor PDCCH for Type1-PDCCH CSS set on the DL BWP. If the UE has not been provided a Type3-PDCCH CSS set or a USS set and the UE has received a C-RNTI and has been provided a Type1-PDCCH CSS set, the UE monitors PDCCH candidates for DCI format 0_0 and DCI format 1_0 with CRC scrambled by the C-RNTI in the Type 1-PDCCH CSS set.

In certain embodiments, if a UE is not provided pagingSearchSpace for Type2-PDCCH CSS set, the UE does not monitor PDCCH for Type2-PDCCH CSS set on the DL BWP. The CCE aggregation levels and the number of PDCCH candidates per CCE aggregation level for Type2-PDCCH CSS set are given in Table 1.

In some embodiments, if a UE is provided a zero value for searchSpaceID in PDCCH-ConfigCommon for a Type0/0A/2-PDCCH CSS set, the UE determines monitoring occasions for PDCCH candidates of the Type0/0A/2-PDCCH CSS set, and the UE is provided a C-RNTI, the UE monitors PDCCH candidates only at monitoring occasions associated with a synchronization signal (“SS”) and/or physical broadcast channel (“PBCH”) block (“SS/PBCH block”), where the SS/PBCH block is determined by the most recent of: 1) a medium access control (“MAC”) CE activation command indicating a transmission configuration indicator (“TCI”) state of the active BWP that includes a CORESET with index 0, where the TCI-state includes a channel state information reference signal (“CSI-RS”) which is quasi-co-located with the SS/PBCH block, or 2) a random access procedure that is not initiated by a PDCCH order that triggers a contention-free random access procedure.

In various embodiments, if a UE monitors PDCCH candidates for DCI formats with CRC scrambled by a C-RNTI and the UE is provided a non-zero value for searchSpaceID in PDCCH-ConfigCommon for a Type0/0A/2-PDCCH CSS set, the UE determines monitoring occasions for PDCCH candidates of the Type0/0A/2-PDCCH CSS set based on the search space set associated with the value of searchSpaceID.

In certain embodiments, the UE may assume that the demodulation (“DM”)-RS antenna port associated with PDCCH receptions in the CORESET configured by pdcch-ConfigSIB1 in MIB, the DM-RS antenna port associated with corresponding physical downlink shared channel (“PDSCH”) receptions, and the corresponding SS/PBCH block are quasi co-located with respect to average gain, quasi co-location ‘typeA’ and ‘typeD’ properties, if the UE is not provided a TCI state indicating quasi co-location information of the DM-RS antenna port for PDCCH reception in the CORESET. The value for the DM-RS scrambling sequence initialization is the cell identifier (“ID”). A SCS is provided by subCarrierSpacingCommon in MIB.

In some embodiments, for single cell operation or for operation with carrier aggregation in a same frequency band, a UE does not expect to monitor a PDCCH in a Type0/0A/2/3-PDCCH CSS set or in a USS set if a DM-RS for monitoring a PDCCH in a Type1-PDCCH CSS set is not configured with same qcl-Type set to ‘typeD’ properties with a DM-RS for monitoring the PDCCH in the Type0/0A/2/3-PDCCH CSS set or in the USS set, and if the PDCCH or an associated PDSCH overlaps in at least one symbol with a PDCCH the UE monitors in a Type 1-PDCCH CSS set or with an associated PDSCH.

In various embodiments, if a UE is provided with one or more search space sets by corresponding one or more of search SpaceZero, search SpaceSIB1, searchSpaceOtherSystemInformation, pagingSearchSpace, ra-SearchSpace, and a C-RNTI, an MCS-C-RNTI, or a CS-RNTI, the UE monitors PDCCH candidates for DCI format 0_0 and DCI format 1_0 with CRC scrambled by the C-RNTI, the MCS-C-RNTI, or the CS-RNTI in the one or more search space sets in a slot where the UE monitors PDCCH candidates for at least a DCI format 0_0 or a DCI format 1_0 with CRC scrambled by SI-RNTI, RA-RNTI, MsgB-RNTI, or P-RNTI.

In certain embodiments, if a UE is provided with one or more search space sets by corresponding one or more of search Space Zero, search SpaceSIB1, searchSpaceOtherSystemInformation, pagingSearchSpace, ra-SearchSpace, or a CSS set by PDCCH-Config, and a SI-RNTI, a P-RNTI, a RA-RNTI, a MsgB-RNTI, a SFI-RNTI, an INT-RNTI, a TPC-PUSCH-RNTI, a TPC-PUCCH-RNTI, or a TPC-SRS-RNTI, then, for a RNTI from any of these RNTIs, the UE does not expect to process information from more than one DCI format with CRC scrambled with the RNTI per slot.

TABLE 1
CCE aggregation levels and maximum number of
PDCCH candidates per CCE aggregation level
for CSS sets configured by searchSpaceSIB1

| CCE | |
|---|---|
| Aggregation | Number of |
| Level | Candidates |
| 4 | 4 |
| 8 | 2 |
| 16 | 1 |

In some embodiments, for each DL BWP configured to a UE in a serving cell, the UE can be provided by higher layer signaling with: 1) P≤3 CORESETs if coresetPoolIndex is not provided, or if a value of coresetPoolIndex is same for all CORESETs if coresetPoolIndex is provided; and 2) P≤5 CORESETs if coresetPoolIndex is not provided for a first CORESET, or is provided and has a value 0 for a first CORESET, and is provided and has a value 1 for a second CORESET.

In various embodiments, for each CORESET, the UE is provided the following by ControlResourceSet: 1) a CORESET index p by controlResourceSetId or by controlResourceSetId-v1610, where: a) 0<p<12 if coresetPoolIndex is not provided, or if a value of coresetPoolIndex is same for all CORESETs if coresetPoolIndex is provided, and b) 0<p<16 if coresetPoolIndex is not provided for a first CORESET, or is provided and has a value 0 for a first CORESET, and is provided and has a value 1 for a second CORESET: 2) a DM-RS scrambling sequence initialization value by pdcch-DMRS-ScramblingID: 3) a precoder granularity for a number of resource element groups (“REGs”) in the frequency domain where the UE can assume use of a same DM-RS precoder by precoderGranularity: 4) a number of consecutive symbols provided by duration: 5) a set of resource blocks provided by frequency DomainResources: 6) CCE-to-REG mapping parameters provided by cce-REG-Mapping Type: 7) an antenna port quasi co-location, from a set of antenna port quasi co-locations provided by TCI-State, indicating quasi co-location information of the DM-RS antenna port for PDCCH reception in a respective CORESET; and 8) an indication for a presence or absence of a TCI field for a DCI format, other than DCI format 1_0, that schedules PDSCH receptions or indicates SPS PDSCH release or indicates SCell dormancy or indicates a request for a Type-3 hybrid automatic repeat request acknowledgement (“HARQ-ACK”) codebook report without scheduling PDSCH and is transmitted by a PDCCH in CORESET p, by tci-PresentInDCI or tci-PresentDCI-1-2.

In certain embodiments, when precoderGranularity=allContiguousRBs, a UE does not expect: 1) to be configured a set of resource blocks of a CORESET that includes more than four sub-sets of resource blocks that are not contiguous in frequency; and 2) any resource element (“RE”) of a CORESET to overlap with any RE determined from Ite-CRS-ToMatchAround, or from LTE-CRS-PatternList, or with any RE of a SS/PBCH block.

In some embodiments, for each CORESET in a DL BWP of a serving cell, a respective frequency Domain Resources provides a bitmap: 1) if a CORESET is not associated with any search space set configured with freqMonitorLocations, the bits of the bitmap have a one-to-one mapping with non-overlapping groups of 6 consecutive physical resource block (“PRBs”), in ascending order of the PRB index in the DL BWP bandwidth of N_{RB}^{BWP} PRBs with starting common RB position N_{BWP}^{start}, where the first common RB of the first group of 6 PRBs has common RB index 6·┌NBWPstart/6┐ if rb-Offset is not provided, or the first common RB of the first group of 6 PRBs has common RB index N_{BWP}^{start}+N_{RB}^{offset} where N_{RB}^{offset} is provided by rb-Offset; and 2) if a CORESET is associated with at least one search space set configured with freqMonitorLocations, the first N_{RBG,set0}^{size} bits of the bitmap have a one-to-one mapping with non-overlapping groups of 6 consecutive PRBs, in ascending order of the PRB index in each RB set k in the DL BWP bandwidth of N_{RB}^{BWP} PRBs with starting common RB position RB_{s0+k,DL}^{start,μ} where the first common RB of the first group of 6 PRBs has common RB index RB_{s0+k,DL}^{start,μ}+N_{RB}^{offset} and k is indicated by freqMonitorLocations if provided for a search space set: otherwise, k=0. N_{RBG,set0}^{size}=└(N_{RB,set0}^{size}−N_{RB}^{offset})/6┘, N_{RB,set0}^{size} is a number of available PRBs in the RB set 0 for the DL BWP, and N_{RB}^{offset} is provided by rb-Offset or N_{RB}^{offset}=0 if rb-Offset is not provided. If a UE is provided RB sets in the DL BWP, the UE expects that the RBs of the CORESET are within the union of the PRBs in the RB sets of the DL BWP.

In various embodiments, for a CORESET other than a CORESET with index 0: 1) if a UE has not been provided a configuration of TCI state(s) by tci-StatesPDCCH-ToAddList and tci-StatesPDCCH-ToReleaseList for the CORESET, or has been provided initial configuration of more than one TCI states for the CORESET by tci-StatesPDCCH-ToAddList and tci-StatesPDCCH-ToRelease List but has not received a MAC CE activation command for one of the TCI states, the UE assumes that the DM-RS antenna port associated with PDCCH receptions is quasi co-located with the SS/PBCH block the UE identified during the initial access procedure: and 2) if a UE has been provided a configuration of more than one TCI states by tci-StatesPDCCH-ToAddList and tci-StatesPDCCH-ToReleaseList for the CORESET as part of Reconfiguration with sync procedure but has not received a MAC CE activation command for one of the TCI states, the UE assumes that the DM-RS antenna port associated with PDCCH receptions is quasi co-located with the SS/PBCH block or the CSI-RS resource the UE identified during the random access procedure initiated by the Reconfiguration with sync procedure.

In certain embodiments, for a CORESET with index 0, the UE assumes that a DM-RS antenna port for PDCCH receptions in the CORESET is quasi co-located with: 1) the one or more DL RS configured by a TCI state, where the TCI state is indicated by a MAC CE activation command for the CORESET, if any: or 2) a SS/PBCH block the UE identified during a most recent random access procedure not initiated by a PDCCH order that triggers a contention-free random access procedure, if no MAC CE activation command indicating a TCI state for the CORESET is received after the most recent random access procedure.

In some embodiments, for a CORESET other than a CORESET with index 0, if a UE is provided a single TCI state for a CORESET, or if the UE receives a MAC CE activation command for one of the provided TCI states for a CORESET, the UE assumes that the DM-RS antenna port associated with PDCCH receptions in the CORESET is quasi co-located with the one or more DL RS configured by the TCI state. For a CORESET with index 0, the UE expects that a CSI-RS configured with qcl-Type set to ‘typeD’ in a TCI state indicated by a MAC CE activation command for the CORESET is provided by a SS/PBCH block if the UE receives a MAC CE activation command for one of the TCI states, the UE applies the activation command in the first slot that is after slot k+3Nₛₗₒₜ^{subframe,μ} where k is the slot where the UE would transmit a physical uplink control channel (“PUCCH”) with HARQ-ACK information for the PDSCH providing the activation command and μ is the SCS configuration for the PUCCH. The active BWP is defined as the active BWP in the slot when the activation command is applied.

In various embodiments, if the UE is provided by simultaneousTCI-UpdateList1 or simultaneousTCI-UpdateList2 up to two lists of cells for simultaneous TCI state activation, the UE applies the antenna port quasi co-location provided by TCI-States with same activated tci-StateID value to CORESETs with a same index in all configured DL BWPs of all configured cells in a list determined from a serving cell index, where tci-StateID, the CORESET index and the serving cell index are provided by a MAC CE command.

For each DL BWP configured to a UE in a serving cell, the UE is provided by higher layers with S≤10 search space sets where, for each search space set from the S search space sets, the UE is provided the following by SearchSpace: 1) a search space set index s, 0<s<40, by searchSpaceId: 2) an association between the search space set s and a CORESET p by controlResourceSetId or by controlResourceSetId-v1610: 3) a PDCCH monitoring periodicity of kₛ slots and a PDCCH monitoring offset of oₛ slots, by monitoringSlotPeriodicityAndOffset: 4) a PDCCH monitoring pattern within a slot, indicating first symbol(s) of the CORESET within a slot for PDCCH monitoring, by monitoringSymbolsWithinSlot: 5) a duration of Tₛ<kₛ slots indicating a number of slots that the search space set s exists by duration: 6) a number of PDCCH candidates Mₛ^{(L)} per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively: 7) an indication that search space set s is either a CSS set or a USS set by searchSpace Type: 8) if search space set s is a CSS set: a) an indication by dci-Format0-0-AndFormat1-0 to monitor PDCCH candidates for DCI format 0_0 and DCI format 1_0, b) an indication by dci-Format2-0 to monitor one or two PDCCH candidates, or to monitor one PDCCH candidate per RB set if the UE is provided freqMonitorLocations for the search space set, for DCI format 2_0 and a corresponding CCE aggregation level, c) an indication by dci-Format2-1 to monitor PDCCH candidates for DCI format 2_1, d) an indication by dci-Format2-2 to monitor PDCCH candidates for DCI format 2_2, c) an indication by dci-Format2-3 to monitor PDCCH candidates for DCI format 2_3, f) an indication by dci-Format2-4 to monitor PDCCH candidates for DCI format 2_4, and g) an indication by dci-Format2-6 to monitor PDCCH candidates for DCI format 2_6: 9) if search space set s is a USS set, an indication by dci-Formats to monitor PDCCH candidates either for DCI format 0_0 and DCI format 1_0, or for DCI format 0_1 and DCI format 1_1, or an indication by dci-FormatsExt to monitor PDCCH candidates for DCI format 0_2 and DCI format 1_2, or for DCI format 0_1, DCI format 1_1, DCI format 0_2, and DCI format 1_2, or an indication by dci-FormatsSL to monitor PDCCH candidates for DCI format 0_0 and DCI format 1_0, or for DCI format 0_1 and DCI format 1_1, or for DCI format 3_0, or for DCI format 3_1, or for DCI format 3_0 and DCI format 3_1; and 10) a bitmap by freqMonitorLocations, if provided, to indicate an index of one or more RB sets for the search space set s, where the most significant bit (“MSB”) k in the bitmap corresponds to RB set k−1 in the DL BWP. For RB set k indicated in the bitmap, the first PRB of the frequency domain monitoring location confined within the RB set is given by RB_{s0+k,DL}^{start,μ}+N_{RB}^{offset}, where RB_{s0+k,DL}^{start,μ} is the index of first common RB of the RB set k, and N_{RB}^{offset} is provided by rb-Offset or N_{RB}^{offset}=0 if rb-Offset is not provided. For each RB set with a corresponding value of 1 in the bitmap, the frequency domain resource allocation pattern for the monitoring location is determined based on the first N_{RBG,set 0}^{size} bits in frequency Domain Resources provided by the associated CORESET configuration.

In certain embodiments, if the monitoringSymbolsWithinSlot indicates to a UE to monitor PDCCH in a subset of up to three consecutive symbols that are same in every slot where the UE monitors PDCCH for all search space sets, the UE does not expect to be configured with a PDCCH SCS other than 15 kHz if the subset includes at least one symbol after the third symbol. A UE does not expect to be provided a first symbol and a number of consecutive symbols for a CORESET that results to a PDCCH candidate mapping to symbols of different slots. A UE does not expect any two PDCCH monitoring occasions on an active DL BWP, for a same search space set or for different search space sets, in a same CORESET to be separated by a non-zero number of symbols that is smaller than the CORESET duration. A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ)modkₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots.

In some embodiments, a USS at CCE aggregation level L∈{1, 2, 4, 8, 16} is defined by a set of PDCCH candidates for CCE aggregation level L. If a UE is configured with CrossCarrierSchedulingConfig for a serving cell the carrier indicator field value corresponds to the value indicated by CrossCarrierSchedulingConfig. For an active DL BWP of a serving cell on which a UE monitors PDCCH candidates in a USS, if the UE is not configured with a carrier indicator field, the UE monitors the PDCCH candidates without carrier indicator field. For an active DL BWP of a serving cell on which a UE monitors PDCCH candidates in a USS, if a UE is configured with a carrier indicator field, the UE monitors the PDCCH candidates with carrier indicator field.

In various embodiments, a UE does not expect to monitor PDCCH candidates on an active DL BWP of a secondary cell if the UE is configured to monitor PDCCH candidates with carrier indicator field corresponding to that secondary cell in another serving cell. For the active DL BWP of a serving cell on which the UE monitors PDCCH candidates, the UE monitors PDCCH candidates at least for the same serving cell.

For a search space set s associated with CORESET p, the CCE indexes for aggregation level L corresponding to PDCCH candidate m_{s,n}_{_{Cl}} of the search space set in slot n_{s,f}^{μ} for an active DL BWP of a serving cell corresponding to carrier indicator field value n_{Cl} are given by

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , m ax}^{( L )}} ⌋ + {n}_{CI} ) mod ⌊ {N}_{CCE , p} / L ⌋ \} + i$$

where: for any CSS, Y_{p,n}_{_{s,f}}_{^{μ}}=0: for a USS, Y_{p,n}_{_{s,f}}_{^{μ}}=(Aₚ·Y_{p,n}_{_{s,f}}_{^{μ}}₋₁)mod D, Y_{p,-1}=n_{RNTI}≠0, Aₚ=39827 for p mod 3=0, Aₚ=39829 for p mod 3=1, Aₚ=39839 for p mod 3=2, and D=65537: i=0, . . . , L−1: N_{CCE,p} is the number of CCEs, numbered from 0 to N_{CCE,p}−1, in CORESET p and, if any, per RB set: n_{Cl} is the carrier indicator field value if the UE is configured with a carrier indicator field by CrossCarrierScheduling Config for the serving cell on which PDCCH is monitored: otherwise, including for any CSS, n_{Cl}=0: m_{s,n}_{_{Cl}}=0, . . . , M_{s,n}_{_{Cl}}^{(L)}−1, where M_{s,n}_{_{Cl}}^{(L)} is the number of PDCCH candidates the UE is configured to monitor for aggregation level L of a search space set s for a serving cell corresponding to n_{Cl}; for any CSS, M_{s,max}^{(L)}=M_{s,0}^{(L)}; for a USS, M_{s,max}^{(L)} is the maximum of M_{s,n}_{_{Cl}}^{(L)} over all configured n_{Cl} values for a CCE aggregation level L of search space set s; and the RNTI value used for n_{RNTI} is the C-RNTI.

In certain embodiments, a UE does not expect to be provided freqMonitorLocations for a search space set s in a serving cell if intraCellGuardBandsDL-List indicates that no intra-cell guard-bands are configured for the serving cell.

In some embodiments, a UE that: a) is configured for operation with carrier aggregation, b) indicates support of search space sharing through searchSpaceSharingCA-UL or through searchSpaceSharingCA-DL, and c) has a PDCCH candidate with CCE aggregation level L in CORESET p for a first DCI format scheduling physical uplink shared channel (“PUSCH”) transmission or UL grant Type 2 PUSCH release, other than DCI format 0_0, or for a second DCI format scheduling PDSCH reception or SPS PDSCH release or indicating SCell dormancy or indicating a request for a Type-3 HARQ-ACK codebook report without scheduling PDSCH, other than DCI format 1_0, having a first size and associated with serving cell n_{Cl,2}, can receive a corresponding PDCCH through a PDCCH candidate with CCE aggregation level L in CORESET p for a first DCI format or for a second DCI format, respectively, having a second size and associated with serving cell n_{Cl,1}, if the first size and the second size are same.

In various embodiments, a UE expects to monitor PDCCH candidates for up to 4 sizes of DCI formats that include up to 3 sizes of DCI formats with CRC scrambled by C-RNTI per serving cell. The UE counts a number of sizes for DCI formats per serving cell based on a number of configured PDCCH candidates in respective search space sets for the corresponding active DL BWP.

In certain embodiments, a UE does not expect to detect, in a same PDCCH monitoring occasion, a DCI format with CRC scrambled by a SI-RNTI, RA-RNTI, MsgB-RNTI, TC-RNTI, P-RNTI, C-RNTI, CS-RNTI, or MCS-RNTI and a DCI format with CRC scrambled by a SL-RNTI or a SL-CS-RNTI for scheduling respective PDSCH reception and physical sidelink shared channel (“PSSCH”) transmission on a same serving cell.

In some embodiments, a PDCCH candidate with index mₛ_{ⱼ}_{,n}_{_{Cl}} for a search space set sⱼ using a set of CCEs in a CORESET p on the active DL BWP for serving cell n_{Cl} is not counted for monitoring if there is a PDCCH candidate with index mₛ_{ᵢ}_{,n}_{_{Cl}} for a search space set sᵢ<sⱼ, or if there is a PDCCH candidate with index nₛ_{ⱼ}_{,n}_{_{Cl}} and nₛ_{ⱼ}_{,n}_{_{Cl}}<mₛ_{ⱼ}_{,n}_{_{Cl}}, in the CORESET p on the active DL BWP for serving cell n_{Cl} using a same set of CCEs, the PDCCH candidates have identical scrambling, and the corresponding DCI formats for the PDCCH candidates have a same size; otherwise, the PDCCH candidate with index mₛ_{ⱼ}_{,n}_{_{Cl}} is counted for monitoring.

Table 2 provides the maximum number of monitored PDCCH candidates, M_{PDCCH}^{max,slot,μ}, per slot for a UE in a DL BWP with SCS configuration μ for operation with a single serving cell.

TABLE 2
Maximum number M_{PDCCH}^{max,slot,μ} of monitored PDCCH
candidates per slot for a DL BWP with SCS configuration
μ ϵ {0, 1, 2, 3} for a single serving cell

| | Maximum number of monitored |
|---|---|
| | PDCCH candidates per slot and |
| μ | per serving cell M_{PDCCH}^{max,slot,μ} |
| 0 | 44 |
| 1 | 36 |
| 2 | 22 |
| 3 | 20 |

Table 3 provides the maximum number of monitored PDCCH candidates, M_{PDCCH}^{max,(X,Y),μ}, per span for a UE in a DL BWP with SCS configuration u for operation with a single serving cell.

TABLE 3
Maximum number M_{PDCCH}^{max,(X,Y),μ} of monitored PDCCH
candidates in a span for combination (X, Y) for a DL BWP
with SCS configuration μ ϵ {0, 1} for a single serving cell

| | Maximum number M_{PDCCH}^{max,(X,Y),μ} of monitored | | |
|---|---|---|---|
| | PDCCH candidates per span for combination | | |
| | (X, Y) and per serving cell | | |
| μ | (2, 2) | (4, 3) | (7, 3) |
| 0 | 14 | 28 | 44 |
| 1 | 12 | 24 | 36 |

Table 4 provides the maximum number of non-overlapped CCEs, C_{PDCCH}^{max,slot,μ}, for a DL BWP with SCS configuration μ that a UE is expected to monitor corresponding PDCCH candidates per slot for operation with a single serving cell. In certain embodiments: CCEs for PDCCH candidates are non-overlapped if they correspond to different CORESET indexes, or different first symbols for the reception of the respective PDCCH candidates.

TABLE 4
Maximum number C_{PDCCH}^{max,slot,μ} of non-overlapped
CCEs per slot for a DL BWP with SCS configuration
μ ϵ {0, 1, 2, 3} for a single serving cell

| | Maximum number of non-overlapped CCEs |
|---|---|
| μ | per slot and per serving cell C_{PDCCH}^{max,slot,μ} |
| 0 | 56 |
| 1 | 56 |
| 2 | 48 |
| 3 | 32 |

Table 5 provides the maximum number of non-overlapped CCEs, C_{PDCCH}^{max,(X,Y),λ}, for a DL BWP with SCS configuration u that a UE is expected to monitor corresponding PDCCH candidates per span for operation with a single serving cell.

TABLE 5
Maximum number C_{PDCCH}^{max,(X,Y),μ} of non-overlapped CCEs
in a span for combination (X, Y) for a DL BWP with
SCS configuration μ ϵ {0, 1} for a single serving cell

| | Maximum number C_{PDCCH}^{max,(X,Y),μ} of | | |
|---|---|---|---|
| | non-overlapped CCEs per span for combination | | |
| | (X, Y) and per serving cell | | |
| μ | (2, 2) | (4, 3) | (7, 3) |
| 0 | 18 | 36 | 56 |
| 1 | 18 | 36 | 56 |

If a UE: does not report pdcch-BlindDetectionCA or is not provided BDFactorR, γ=R; and/or reports pdcch-BlindDetectionCA, the UE can be indicated by BDFactorR either γ=1 or γ=R.

In various embodiments, if a UE is configured with N_{cells,0}^{DL,μ}+N_{cells,1}^{DL,μ} downlink cells for which the UE is not provided monitoringCapabilityConfig-r16, or is provided monitoringCapabilityConfig-r16=r15monitoringcapability but not provided CORESETPoolIndex, with associated PDCCH candidates monitored in the active DL BWPs of the scheduling cells using SCS configuration u where Σ_{μ=0}³(N_{cells,0}^{DL,μ}+γ·N_{cells,1}^{DL,μ})≤N_{cells}^{cap}, the UE is not required to monitor, on the active DL BWPs of the scheduling cells: 1) more than M_{PDCCH}^{total,slot,μ}=M_{PDCCH}^{max,slot,μ} PDCCH candidates or more than C_{PDCCH}^{total,slot,μ}=C_{PDCCH}^{max,slot,μ} non-overlapped CCEs per slot for each scheduled cell when the scheduling cell is from the N_{cells,0}^{DL,μ} downlink cells; 2) more than M_{PDCCH}^{total,slot,μ}=γ·M_{PDCCH}^{max,slot,μ} PDCCH candidates or more than C_{PDCCH}^{total,slot,μ}=γ·C_{PDCCH}^{max,slot,μ} non-overlapped CCEs per slot for each scheduled cell when the scheduling cell is from the N_{cells,1}^{DL,μ} downlink cells: or 3) more than M_{PDCCH}^{max,slot,μ} PDCCH candidates or more than C_{PDCCH}^{max,slot,μ} non-overlapped CCEs per slot for CORESETs with same coresetPoolIndex value for each scheduled cell when the scheduling cell is from the N_{cells,1}^{DL,μ} downlink cells.

N_{cells}^{cap} is replaced by N_{cells,r15}^{cap-r16}, if a UE is configured with downlink cells for which the UE is provided both monitoringCapabilityConfig-r16=r15monitoringcapability and monitoringCapabilityConfig-r16=r16monitoringcapability.

If a UE: is configured with N_{cells,0}^{DL,μ}+N_{cells,1}^{DL,μ} downlink cells for which the UE is not provided monitoringCapabilityConfig, or is provided monitoringCapabilityConfig-r16=r15monitoringcapability but not provided coresetPoolIndex, with associated PDCCH candidates monitored in the active DL BWPs of the scheduling cell(s) using SCS configuration μ, where Σ_{μ=0}³(N_{cells,0}^{DL,μ}+γ·N_{cells,1}^{DL,μ})>N_{cells}^{cap}; and a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than M_{PDCCH}^{total,slot,μ}=└N_{cells}^{cap}·M_{PDCCH}^{max,slot,μ}·(N_{cells,0}^{DL,μ}+γ·_{cells,1}^{DL,μ})/Σⱼ₌₀³(N_{cells,0}^{DL,j}+γ·N_{cells,1}^{DL,j})┘ PDCCH candidates or more than C_{PDCCH}^{total,slot,μ}=└N_{cells}^{cap}·C_{PDCCH}^{max,slot,μ}·(N_{cells,0}^{DL,μ}+γ·N_{cells,1}^{DL,μ})/Σⱼ₌₀³(N_{cells,0}^{DL,j}+γ·N_{cells,1}^{DL,j})┘ non-overlapped CCEs per slot on the active DL BWP(s) of scheduling cell(s) from the N_{cells,0}^{DL,μ}+N_{cells,1}^{DL,μ} downlink cells. N_{cells}^{cap} is replaced by N_{cells,r15}^{cap-r16} if a UE is configured with downlink cells for which the UE is provided both monitoringCapabilityConfig-r16=r15monitoringcapability and monitoringCapabilityConfig-r16=r16monitoringcapability.

In certain embodiments, for each scheduled cell from the N_{cells,0}^{DL,μ} downlink cells, the UE is not required to monitor on the active DL BWP with SCS configuration u of the scheduling cell more than min(M_{PDCCH}^{max,slot,μ},M_{PDCCH}^{total,slot,μ}) PDCCH candidates or more than min(C_{PDCCH}^{max,slot,μ},C_{PDCCH}^{total,slot,μ}) non-overlapped CCEs per slot.

In some embodiments, for each scheduled cell from the N_{cells,1}^{DL,μ} downlink cells, the UE is not required to monitor on the active DL BWP with SCS configuration u of the scheduling cell: 1) more than min(γ·M_{PDCCH}^{max,slot,μ},M_{PDCCH}^{total,slot,μ}) PDCCH candidates or more than min(γ·_{PDCCH}^{max,slot,μ},C_{PDCCH}^{total,slot,μ}) non-overlapped CCEs per slot; and 2) more than min(M_{PDCCH}^{max,slot,μ},M_{PDCCH}^{total,slot,μ}) PDCCH candidates or more than min(C_{PDCCH}^{max,slot,μ},C_{PDCCH}^{total,slot,μ}) non-overlapped CCEs per slot for CORESETs with same coresetPoolIndex value.

In various embodiments, if a UE is configured with N_{cells,r16}^{DL,μ} downlink cells for which the UE is provided monitoringCapabilityConfig=r16monitoringcapability and with associated PDCCH candidates monitored in the active DL BWPs of the scheduling cells using SCS configuration μ, and with N_{cells,r16}^{DL,(X,Y),μ} of the N_{cells,r16}^{DL,μ} downlink cells using combination (X,Y) for PDCCH monitoring, where Σ_{μ=0}¹N_{cells,r16}^{DL,μ}≤N_{cells}^{cap-r16}, the UE is not required to monitor, on the active DL BWP of the scheduling cell, more than M_{PDCCH}^{total,(X,Y),μ}=M_{PDCCH}^{max,(X,Y),μ} PDCCH candidates or more than C_{PDCCH}^{total,(X,Y),μ}=C_{PDCCH}^{max,(X,Y),μ} non-overlapped CCEs per span for each scheduled cell when the scheduling cell is from the N_{cells,r16}^{DL,(X,Y),μ} downlink cells. If a UE is configured with downlink cells for which the UE is provided both monitoringCapabilityConfig=r15monitoringcapability and monitoringCapabilityConfig=r16monitoringcapability, N_{cells}^{cap-r16} is replaced by N_{cells,r16}^{cap-r16}.

In certain embodiments, if a UE is configured only with N_{cells,r16}^{DL,μ} downlink cells for which the UE is provided monitoringCapabilityConfig=r16monitoringcapability and with associated PDCCH candidates monitored in the active DL BWPs of the scheduling cells using SCS configuration μ, and with N_{cells,r16}^{DL,(X,Y),μ} of the N_{cells,r16}^{DL,μ} downlink cells using combination (X,Y) for PDCCH monitoring, where Σ_{μ=0}¹N_{cells,r16}^{DL,μ}>N_{cells}^{cap-r16}, a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than M_{PDCCH}^{total,(X,Y),μ}=└N_{cells}^{cap-r16}·M_{PDCCH}^{max,(X,Y),μ}·N_{cells,r16}^{DL,(X,Y),μ}/Σⱼ₌₀¹N_{cells,r16}^{DL,j}┘ PDCCH candidates or more than C_{PDCCH}^{total,(X,Y),μ}=└N_{cells}^{cap-r16}·C_{PDCCH}^{max,(X,Y),μ}·N_{cells,r16}^{DL,(X,Y),μ}/Σⱼ₌₀¹N_{cells,r16}^{DL,j}┘ non- overlapped CCEs: 1) per set of spans on the active DL BWP(s) of all scheduling cell(s) from the N_{cells,r16}^{DL,(X,Y),μ} downlink cells within every X symbols, if the union of PDCCH monitoring occasions on all scheduling cells from the N_{cells,r16}^{DL,(X,Y),μ} downlink cells results to PDCCH monitoring according to the combination (X,Y) and any pair of spans in the set is within Y symbols, where first X symbols start at a first symbol with a PDCCH monitoring occasion and next X symbols start at a first symbol with a PDCCH monitoring occasion that is not included in the first X symbols; and 2) per set of spans across the active DL BWP(s) of all scheduling cells from the N_{cells,r16}^{DL,(X,Y),μ} downlink cells, with at most one span per scheduling cell for each set of spans, otherwise, where N_{cells,r16}^{DL,j} is a number of configured cells with associated PDCCH candidates monitored in the active DL BWPs of the scheduling cells using SCS configuration j. If a UE is configured with downlink cells for which the UE is provided both monitoringCapabilityConfig=r15monitoringcapability and monitoringCapabilityConfig=r16monitoringcapability. N_{cells}^{cap-r16} is replaced by N_{cells,r16}^{cap-r16}.

In some embodiments, for each scheduled cell from the N_{cells,r16}^{DL,(X,Y),μ} downlink cells using combination (X,Y), the UE is not required to monitor on the active DL BWP with SCS configuration μ of the scheduling cell, more than min(M_{PDCCH}^{max,(X,Y),μ},M_{PDCCH}^{total,(X,Y),μ}) PDCCH candidates or more than min(C_{PDCCH}^{max,(X,Y),μ},C_{PDCCH}^{total,(X,Y),μ}) non-overlapped CCEs per span.

In various embodiments, a UE does not expect to be configured CSS sets that result to corresponding total, or per scheduled cell, numbers of monitored PDCCH candidates and non-overlapped CCEs per slot or per span that exceed the corresponding maximum numbers per slot or per span, respectively.

In certain embodiments, for same cell scheduling or for cross-carrier scheduling, a UE does not expect a number of PDCCH candidates, and a number of corresponding non-overlapped CCEs per slot or per span on a secondary cell to be larger than the corresponding numbers that the UE is capable of monitoring on the secondary cell per slot or per span, respectively. If a UE is provided monitoringCapabilityConfig=r16monitoringcapability for the primary cell, except the first span of each slot, the UE does not expect a number of PDCCH candidates and a number of corresponding non-overlapped CCEs per span on the primary cell to be larger than the corresponding numbers that the UE is capable of monitoring on the primary cell per span.

For cross-carrier scheduling, the number of PDCCH candidates for monitoring and the number of non-overlapped CCEs per span or per slot are separately counted for each scheduled cell. For all search space sets within a slot n or within a span in slot n, denote by S_{css} a set of CSS sets with cardinality of I_{css} and by Sᵤₛₛ a set of USS sets with cardinality of Jᵤₛₛ. The location of USS sets sⱼ, 0≤j<Jᵤₛₛ, in Sᵤₛₛ is according to an ascending order of the search space set index.

In some embodiments, denoted by M_{S}_{_{css}}₍ᵢ₎^{(L)}, 0≤i<I_{css}, the number of counted PDCCH candidates for monitoring for CSS set S_{css}(i) and by M_{S}_{ᵤₛₛ}₍ⱼ₎^{(L)}, 0≤j<Jᵤₛₛ, the number of counted PDCCH candidates for monitoring for USS set Sᵤₛₛ(j).

For the CSS sets, a UE monitors

$${M}_{PDCCH}^{CSS} = {\sum }_{i = 0}^{{I}_{css} - 1} {\sum }_{L} {M}_{{S}_{css} ( i )}^{( L )}$$

PDCCH candidates requiring a total of C_{PDCCH}^{CSS} non-overlapping CCEs in a slot or in a span.

In various embodiments, the UE allocates PDCCH candidates for monitoring to USS sets for the primary cell having an active DL BWP with SCS configuration μ in a slot if the UE is not provided monitoringCapabilityConfig for the primary cell or if the UE is provided monitoringCapabilityConfig=r15monitoringcapability for the primary cell, or in the first span of each slot if the UE is provided monitoringCapabilityConfig=r16monitoringcapability for the primary cell, according to the following pseudocode. If for the USS sets for scheduling on the primary cell the UE is not provided coresetPoolIndex for first CORESETs, or is provided coresetPoolIndex with value 0 for first CORESETs, and is provided coresetPoolIndex with value 1 for second CORESETs, and if min(γ·M_{PDCCH}^{max,slot,μ},M_{PDCCH}^{total,slot,μ})>min(M_{PDCCH}^{max,slot,μ},M_{PDCCH}^{total,slot,μ}) or min(γ·C_{PDCCH}^{max,slot,μ},C_{PDCCH}^{total,slot,μ})>min (C_{PDCCH}^{max,slot,μ},C_{PDCCH}^{total,slot,μ}) the following pseudocode applies only to USS sets associated with the first CORESETs. A UE does not expect to monitor PDCCH in a USS set without allocated PDCCH candidates for monitoring. In the following pseudocode, if the UE is provided monitoringCapabilityConfig=r16monitoringcapability for the primary cell, M_{PDCCH}^{max,slot,μ} and C_{PDCCH}^{max,slot,μ} are replaced by M_{PDCCH}^{max,(X,Y),μ} and C_{PDCCH}^{max,(X,Y),μ} respectively, and M_{PDCCH}^{total,slot,μ} and C_{PDCCH}^{total,slot,μ} are replaced by M_{PDCCH}^{total,(X,Y),μ} and C_{PDCCH}^{total,(X,Y),μ} respectively.

In certain embodiments, denoted by V_{CCE}(Sᵤₛₛ(j)), the set of non-overlapping CCEs for search space set Sᵤₛₛ(j) and by [symbol] (V_{CCE}(Sᵤₛₛ(j))) the cardinality of V_{CCE}(Sᵤₛₛ(j)) where the non-overlapping CCEs for search space set Sᵤₛₛ(j) are determined considering the allocated PDCCH candidates for monitoring for the CSS sets and the allocated PDCCH candidates for monitoring for all search space sets Sᵤₛₛ(k), 0≤k≤j.

Set M_{PDCCH}^{uss}=min(M_{PDCCH}^{max,slot,μ},M_{PDCCH}^{total,slot,μ})−M_{PDCCH}^{css}.

Set C_{PDCCH}^{uss}=min(C_{PDCCH}^{max,slot,μ},C_{PDCCH}^{total,slot,μ})−C_{PDCCH}^{css}.

Set j=0, while

$${\sum }_{L} {M}_{{S}_{uss} ( j )}^{( L )} \leq {M}_{PDCCH}^{uss}$$

AND [symbol] (V_{CCE}(Sᵤₛₛ(j)))≤C_{PDCCH}^{uss}, allocate

$${\sum }_{L} {M}_{{S}_{uss} ( j )}^{( L )}$$

PDCCH candidates for monitoring to USS set

$${S}_{uss} ( j ) {M}_{PDCCH}^{uss} = {M}_{PDCCH}^{uss} - {\sum }_{L} {M}_{{S}_{uss} ( j )}^{( L )} ;$$

$${C}_{PDCCH}^{uss} = {C}_{PDCCH}^{uss} - 𝒞 ( {V}_{CCE} ( {S}_{uss} ( j ) ) ) ;$$

$$j = j + 1 ;$$

end while.

If a UE: is configured for single cell operation or for operation with carrier aggregation in a same frequency band, and monitors PDCCH candidates in overlapping PDCCH monitoring occasions in multiple CORESETs that have been configured with same or different qcl-Type set to ‘typeD’ properties on active DL BWP(s) of one or more cells, then the UE monitors PDCCHs only in a CORESET, and in any other CORESET from the multiple CORESETs that have been configured with qcl-Type set to same ‘typeD’ properties as the CORESET, on the active DL BWP of a cell from the one or more cells, the CORESET corresponds to the CSS set with the lowest index in the cell with the lowest index containing CSS, if any: otherwise, to the USS set with the lowest index in the cell with lowest index, the lowest USS set index is determined over all USS sets with at least one PDCCH candidate in overlapping PDCCH monitoring occasions, for the purpose of determining the CORESET, a SS/PBCH block is considered to have different QCL ‘typeD’ properties than a CSI-RS, for the purpose of determining the CORESET, a first CSI-RS associated with a SS/PBCH block in a first cell and a second CSI-RS in a second cell that is also associated with the SS/PBCH block are assumed to have same QCL ‘typeD’ properties, the allocation of non-overlapping CCEs and of PDCCH candidates for PDCCH monitoring is according to all search space sets associated with the multiple CORESETs on the active DL BWP(s) of the one or more cells, the number of active TCI states is determined from the multiple CORESETs.

In some embodiments, if a UE: is configured for single cell operation or for operation with carrier aggregation in a same frequency band, and monitors PDCCH candidates in overlapping PDCCH monitoring occasions in multiple CORESETs where none of the CORESETs has TCI-states configured with qcl-Type set to ‘typeD’, the UE is required to monitor PDCCH candidates in overlapping PDCCH monitoring occasions for search space sets associated with different CORESETs.

In various embodiments, for a scheduled cell and at any time, a UE expects to have received at most 16 PDCCHs for DCI formats with CRC scrambled by C-RNTI, CS-RNTI, or MCS-C-RNTI scheduling 16 PDSCH receptions for which the UE has not received any corresponding PDSCH symbol and at most 16 PDCCHs for DCI formats with CRC scrambled by C-RNTI, CS-RNTI, or MCS-C-RNTI scheduling 16 PUSCH transmissions for which the UE has not transmitted any corresponding PUSCH symbol.

If a UE is not provided monitoringCapabilityConfig=r16monitoringcapability for any serving cell, and is not configured for new radio dual connectivity (“NR-DC”) operation and indicates through pdcch-BlindDetectionCA a capability to monitor PDCCH candidates for N_{cells}^{cap}≥4 downlink cells and the UE is configured with N_{cells}^{DL}>4 downlink cells or N_{cells}^{UL}>4 uplink cells, or is configured with NR-DC operation and for a cell group with N_{cells}^{DL} downlink cells or N_{cells}^{UL} uplink cells, the UE expects to have respectively received at most 16·N_{cells}^{cap} PDCCHs for: DCI formats with CRC scrambled by a C-RNTI, or a CS-RNTI, or a MCS-C-RNTI scheduling 16·N_{cells}^{cap} PDSCH receptions for which the UE has not received any corresponding PDSCH symbol over all N_{cells}^{DL} downlink cells; and DCI formats with CRC scrambled by a C-RNTI, or a CS-RNTI, or a MCS-C-RNTI scheduling 16·N_{cells}^{cap} PUSCH transmissions for which the UE has not transmitted any corresponding PUSCH symbol over all N_{cells}^{UL} cells uplink cells.

If a UE is provided monitoringCapabilityConfig=r16monitoringcapability for all serving cells, and: is not configured for NR-DC operation and indicates through pdcch-MonitoringCA a capability to monitor PDCCH candidates for N_{cells}^{cap-r16}≥2 downlink cells and the UE is configured with N_{cells}^{DL}>2 downlink cells or N_{cells}^{UL}>2 uplink cells, or is configured with NR-DC operation and for a cell group with N_{cells}^{DL} downlink cells or N_{cells}^{UL} uplink cells, the UE expects to have respectively received at most 16·N_{cells}^{cap-r16} PDCCHs for: DCI formats with CRC scrambled by a C-RNTI, or a CS-RNTI, or a MCS-C-RNTI scheduling 16·N_{cells}^{cap-r16} PDSCH receptions for which the UE has not received any corresponding PDSCH symbol over all N_{cells}^{DL} downlink cells; and DCI formats with CRC scrambled by a C-RNTI, or a CS-RNTI, or a MCS-C-RNTI scheduling 16·N_{cells}^{cap-r16} PUSCH transmissions for which the UE has not transmitted any corresponding PUSCH symbol over all N_{cells}^{UL} uplink cells.

If a UE is provided monitoringCapabilityConfig=r16monitoringcapability for at least one serving cell and is not provided monitoringCapabilityConfig=r16monitoringcapability for at least one serving cell, and is not configured for NR-DC operation, and indicates a capability to monitor PDCCH candidates for N_{cells,r15}^{cap-r16}≥1 downlink cells and N_{cells,r16}^{cap-r16}≥1 downlink cells, and the UE is configured with N_{cells}^{DL}>1 downlink cell or N_{cells}^{UL}>1 uplink cell, or is configured with NR-DC operation and for a cell group with N_{cells}^{DL} downlink cells or N_{cells}^{UL} uplink cells, the UE expects to have respectively received: 1) at most 16·N_{cells,r15}^{cap-r16} PDCCHs for DCI formats with CRC scrambled by a C-RNTI, or a CS-RNTI, or a MCS-C-RNTI scheduling 16·N_{cells,r15}^{cap-r16} PDSCH receptions for which the UE has not received any corresponding PDSCH symbol over all serving cells that are not provided monitoringCapabilityConfig=r16monitoringcapability: 2) at most 16·N_{cells,r15}^{cap-r16} PDCCHs for DCI formats with CRC scrambled by a C-RNTI, or a CS-RNTI, or a MCS-C-RNTI scheduling 16·N_{cells,r15}^{cap-r16} PUSCH transmissions for which the UE has not transmitted any corresponding PUSCH symbol over all serving cells that are not provided monitoringCapabilityConfig=r16monitoringcapability: 3) at most 16·N_{cells,r16}^{cap-r16} PDCCHs for DCI formats with CRC scrambled by a C-RNTI, or a CS-RNTI, or a MCS-C-RNTI scheduling 16·N_{cells,r16}^{cap-r16} PDSCH receptions for which the UE has not received any corresponding PDSCH symbol over all serving cells that are provided monitoringCapabilityConfig=r16monitoringcapability; and 4) at most 16·N_{cells,r16}^{cap-r16} PDCCHs for DCI formats with CRC scrambled by a C-RNTI, or a CS-RNTI, or a MCS-C-RNTI scheduling 16·N_{cells,r16}^{cap-r16} PUSCH transmissions for which the UE has not transmitted any corresponding PUSCH symbol over all serving cells that are provided monitoringCapabilityConfig=r16monitoringcapability.

If a UE: is configured to monitor a first PDCCH candidate for a DCI format 0_0 and a DCI format 1_0 from a CSS set and a second PDCCH candidate for a DCI format 0_0 and a DCI format 1_0 from a USS set in a CORESET with index zero on an active DL BWP, and the DCI formats 0_0/1_0 associated with the first PDCCH candidate and the DCI formats 0_0/1_0 associated with the second PDCCH candidate have same size, and the UE receives the first PDCCH candidate and the second PDCCH candidate over a same set of CCEs, and the first PDCCH candidate and the second PDCCH candidate have identical scrambling, and the DCI formats 0_0/1_0 for the first PDCCH candidate and the DCI formats 0_0/1_0 for the second PDCCH candidate have CRC scrambled by either C-RNTI, or MCS-C-RNTI, or CS-RNTI, the UE decodes only the DCI formats 0_0/1_0 associated with the first PDCCH candidate.

If a UE detects a DCI format with inconsistent information, the UE discards all the information in the DCI format.

A UE configured with a bandwidth part indicator in a DCI format determines, in case of an active DL BWP or of an active UL BWP change, that the information in the DCI format is applicable to the new active DL BWP or UL BWP, respectively.

In certain embodiments, for unpaired spectrum operation, if a UE is not configured for PUSCH/PUCCH transmission on serving cell c₂, the UE does not expect to monitor PDCCH on serving cell c₁ if the PDCCH overlaps in time with SRS transmission (including any interruption due to uplink or downlink RF retuning time) on serving cell c₂ and if the UE is not capable of simultaneous reception and transmission on serving cell c₁ and serving cell c₂.

If a UE is provided resourceBlocks and symbolsInResourceBlock in RateMatchPattern, or if the UE is additionally provided periodicityAndPattern in RateMatchPattern, the UE can determine a set of RBs in symbols of a slot that are not available for PDSCH reception. If a PDCCH candidate in a slot is mapped to one or more REs that overlap with REs of any RB in the set of RBs in symbols of the slot, the UE does not expect to monitor the PDCCH candidate.

A UE does not expect to be configured with dci-FormatsSL and dci-FormatsExt in a same USS.

It should be noted that embodiments herein may be used either separately or may be applied in combination. A slot group or multi-slot PDCCH monitoring is used interchangeably to describe a number of consecutive slots over which the PDCCH monitoring is configured, and UE capability is reported.

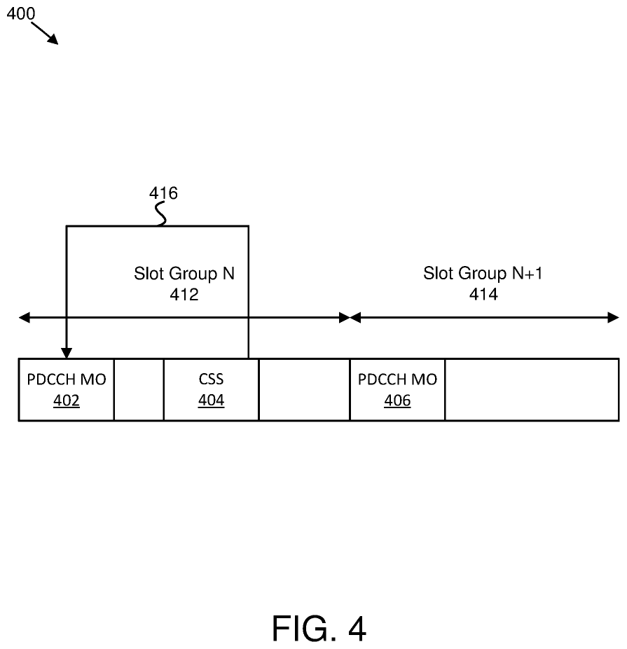

In a first embodiment, there may be CSS associated control information reception on USS. According to the first embodiment, PDCCH monitoring may be performed on CSS and USS with multi-slot PDCCH monitoring when the CSS and USS are misaligned in time for a UE as follows: 1) first, a UE receives a configuration from the network for user-specific search space sets and common search space sets: 2) second, the UE determines whether the CSS is outside the PDCCH monitoring occasions within a slot group: 3) third, if the CSS is outside the PDCCH monitoring occasions within a slot group, then the UE applies the CSS configuration to the USS, monitors for corresponding DCI formats (e.g., intended for CSS) in the USS and is not required to monitor CSS outside the monitoring occasion: 4) fourth, UE checks if the PDCCH BD budget is sufficient to monitor both CSS and USS within the PDCCH monitoring occasions (e.g., according to steps 1-3): 5) fifth, if the UE is expected to exceed the PDCCH blind decoding budget beyond its capability, then some of the BD attempts for PDCCH/DCI in the USS (e.g., not those intended for CSS) are dropped-in one implementation, at least some of the BD attempts for PDCCH and/or DCI in the USS with highest index are dropped-in another implementation, at least some of the BD attempts for a USS configured with specific DCI formats are dropped-if some DCI formats are associated with low priority and some DCI formats are associated with high priority, then the low priority ones can be dropped-in one example, a new DCI format could be introduced to schedule multiple PDSCHs/PUSCHs for FR2-2 with high SCS-therefore, when UE is served in this FR2-2 or configured with high SCS, then UE can prioritize multi-scheduling DCI over single scheduling DCI-in another example, a UE could autonomously deprioritize DCI for UL grants if UE has no data available for transmission; and 6) sixth, the UE monitors the USS in the PDCCH monitoring occasions based on the outcome of the above steps. An illustration of the first embodiment is shown in FIG. 4.

FIG. 4 is a schematic block diagram illustrating one embodiment of a system 400 for monitoring CSS associated information in USS and not monitoring CSS. The system 400 includes a first PDCCH monitoring occasion (“MO”) 402 (e.g., USS), a configured CSS 404 (e.g., configured, but not monitored), and a second PDCCH MO 406 (e.g., USS) over a slot group N 412 and a slot group N+1 414. CSS monitoring 416 is within the PDCCH MO 402 using the USS budget.

In certain embodiments, for the fifth step, if the UE is expected to exceed the PDCCH blind decoding budget beyond its capability, then some priority may be assigned between USS and CSS, and, depending on the priority, either of some BD attempts in USS or CSS may be dropped to accommodate the budget.

In a second embodiment, there may be a blind decoding budget across discontinuous PDCCH monitoring occasions in time and there may be CSS prioritization.

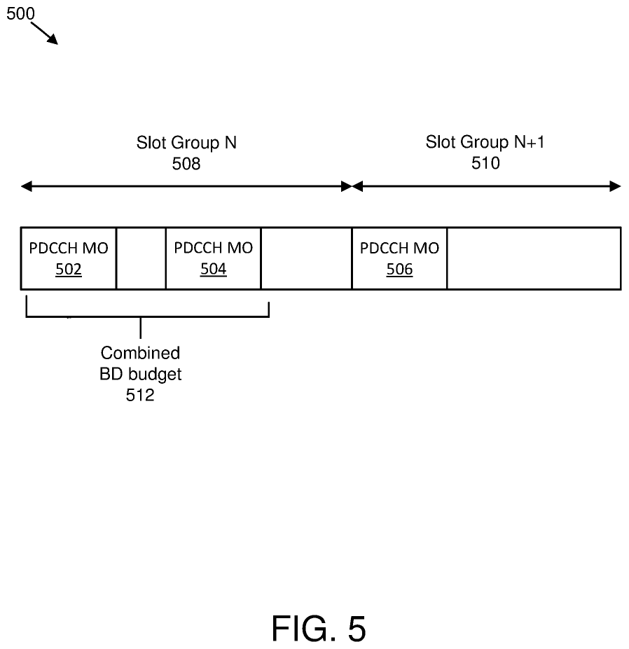

According to the second embodiment, when multiple PDCCH monitoring occasions are configured to a UE within a slot group that may be discontinuous in time, then the following steps may be used for PDCCH monitoring on CSS and USS with multi-slot PDCCH monitoring when the CSS and USS are misaligned in time for a UE: 1) first, a UE receives a configuration from the network for USS sets and CSS sets: 2) second, the UE determines whether the CSS is on different monitoring occasions than USS within a slot group: 3) third, if the CSS is on different PDCCH monitoring occasions than USS within a slot group, then the UE determines the required PDCCH blind decoding budget for both the CSS and USS: 4) fourth, the UE checks if the PDCCH blind decoding budget is sufficient to monitor both CSS and USS within the PDCCH monitoring occasions (e.g., according to steps 1-3): 5) fifth, if the UE is expected to exceed the PDCCH blind decoding budget beyond its capability, then some of the BD attempts for PDCCH and/or DCI in the USS are dropped-in one implementation, the BD attempts for PDCCH and/or DCI in the USS with highest index are dropped-in an alternate implementation, the BD attempts for PDCCH and/or DCI in the USS configured with specific DCI formats are dropped-if some DCI formats are associated with low priority and some DCI formats are associated with high priority, then the BD attempts for low priority DCI formats can be dropped; and 6) sixth, UE monitors the USS and the CSS in the corresponding PDCCH monitoring occasions based on the outcome of the prior steps. An illustration of the second embodiment is shown in FIG. 5.

FIG. 5 is a schematic block diagram illustrating one embodiment of a system 500 for monitoring CSS and USS in separate PDCCH MOs within a slot group. The system 500 includes a first PDCCH MO 502 (e.g., USS), a second PDCCH MO 504 (e.g., CSS), and a third PDCCH MO 506 (e.g., USS) over a slot group N 508 and a slot group N+1 510. The first PDCCH MO 502 and the second PDCCH MO 504 together illustrate a combined BD budget 512.

In certain embodiments, for the fifth step, if the UE is expected to exceed the PDCCH blind decoding budget beyond its capability, then some priority may be assigned between USS and CSS, and, depending on the priority, either of some BD attempts in USS or CSS may be dropped to accommodate the budget.

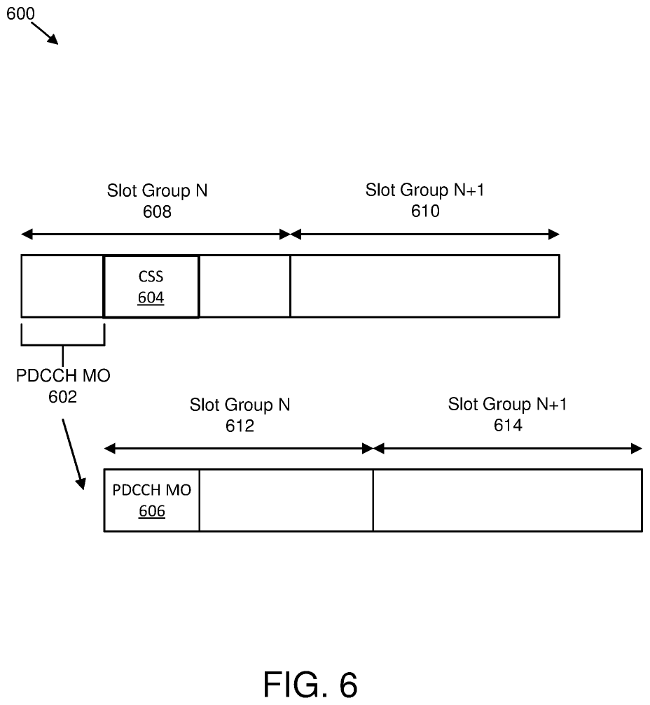

In a third embodiment, there may be a shifting of multi-slot PDCCH monitoring in time to align CSS with PDCCH monitoring occasions within a slot group. According to the third embodiment, when for a given slot group no USS is configured, but only CSS is configured and it is not within the PDCCH monitoring occasions within the slot group, then for PDCCH monitoring on CSS with multi-slot PDCCH monitoring for a UE the following may be performed: 1) first, a UE receives a configuration from the network for USS sets and CSS sets: 2) second, the UE determines whether only CSS is configured within a slot group: 3) third, if only CSS is configured within a slot group, then the UE determines if the CSS is within the PDCCH monitoring occasions within a slot group: 4) fourth, if the UE determines that CSS is not configured within the PDCCH monitoring occasions within a slot group, then UE is expected to apply a time offset (e.g., shift PDCCH monitoring occasions) such that the CSS is aligned with the PDCCH monitoring occasions within a slot group and is completely within the occasions (e.g., according to steps 1-3): and 5) fifth, the UE applies the time offset to all the following slot groups and monitors USS and CSS accordingly (based on the steps herein). An illustration of the third embodiment is shown in FIG. 6.

FIG. 6 is a schematic block diagram illustrating one embodiment of a system 600 for shifting PDCCH MOs to align with CSS. The system 600 includes a first PDCCH MO 602, a CSS 604, and a second PDCCH MO 606 (e.g., CSS) over slot groups N 608 and 612 and slot groups N+1 610 and 614 showing PDCCH MO shifted in time.

In one embodiment, a gNB dedicatedly sends a short-message (e.g., PDCCH using P-RNTI) and SI, including changed SI, to a UE in USS (e.g., using C-RNTI). This allows the UE to not monitor searchSpaceSIB1, searchSpaceOtherSystemInformation, and pagingSearchSpace. To enable this, in a handshake procedure the network needs to confirm to the UE that the UE does not need to monitor these CSSs.

If because of the handshake it is clear to the UE that the network is not sending the SI and/or SI-update dedicatedly to the UE, including a case when such a handshake procedure does not take place, then the following steps may be used for PDCCH monitoring on CSS with multi-slot PDCCH monitoring for a UE: 1) first, the UE receives a configuration from the network for USS sets and CSS sets: 2) second, the UE determines whether the CSS is on different monitoring occasions than USS within a slot group: 3) third, if the CSS is on different PDCCH monitoring occasions than USS within a slot group, then the UE determines the required PDCCH blind decoding budget for both the CSS and USS: 4) fourth, the UE checks if the PDCCH blind decoding budget is sufficient to monitor both CSS and USS within the PDCCH monitoring occasions (e.g., according to steps 1-3); and 5) fifth, if the UE is expected to exceed the PDCCH blind decoding budget than its capability, then UE monitors the searchSpaceSIB1, searchSpaceOtherSystemInformation, pagingSearchSpace for any other UE (e.g., using and/or on the paging occasions meant for any other UE on PDCCH monitoring occasions overlapping with its USS).

In certain embodiments corresponding to a random access procedure, a UE may initiate a random access channel (“RACH”) only on RACH occasions that would allow the ra-ResponseWindow to fall inside of the slot group (e.g., by postponing the RACH procedure transmission towards the next slot group). This might be done for requesting other SI. If this would not be possible due to the urgency of the RACH procedure (e.g., the UE needs to start the RACH procedure as soon as possible for a beam failure recovery procedure), a UE employs one of the first, second, or third embodiment to monitor ra-SearchSpace if the corresponding PDCCH monitoring occasions (e.g., on RA-RNTI) do not fall within the slot group.

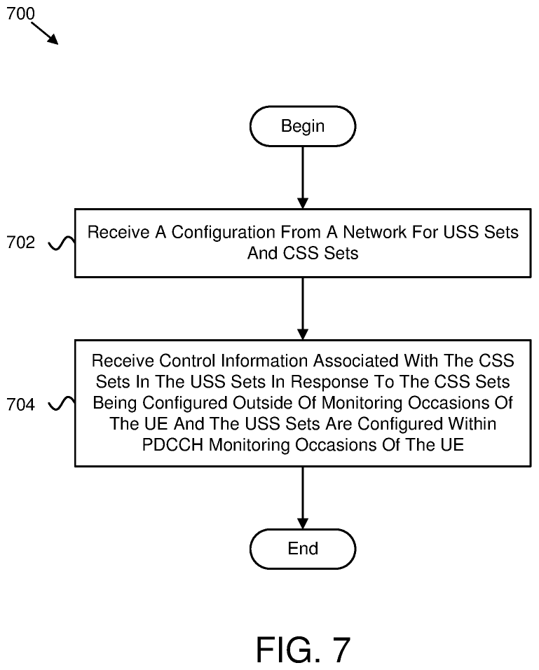

FIG. 7 is a flow chart diagram illustrating one embodiment of a method 700 for configuring a device based on multiple search space sets. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702 a configuration from a network for USS sets and CSS sets. In some embodiments, the method 700 includes receiving 704 control information associated with the CSS sets in the USS sets in response to the CSS sets being configured outside of monitoring occasions of the UE and the USS sets are configured within PDCCH monitoring occasions of the UE.

In certain embodiments, a search space configuration for PDCCH monitoring is configured for slots group, the PDCCH monitoring occasions within the slot groups are continuous across at least one slot, a minimum gap between multiple PDCCH monitoring occasions across multiple slot groups is greater than a UE reported capability, and, in response to a CSS being configured between two PDCCH monitoring occasions, not being required to monitor the CSS. In some embodiments, a USS of the USS sets with a lowest index is replaced with at least one CSS configuration.

In some embodiments, the method 700 further comprising expecting to drop the USS in response to the blind decoding budget being exceeded. In various embodiments, the method 700 further comprises expecting to drop low priority downlink control information (DCI) formats corresponding to the USS. In certain embodiments, the method 700 further comprises expecting to drop DCI formats of an uplink (UL) grant in response to there being no UL data to be transmitted by the UE.

In some embodiments, a priority may be assigned to the USS and the CSS to be able drop one with a least priority in response to the UE exceeding the blind decoding budget. In various embodiments, the method 700 further comprising expecting to prioritize monitoring of CSS within the PDCCH monitoring occasion using the USS budget.

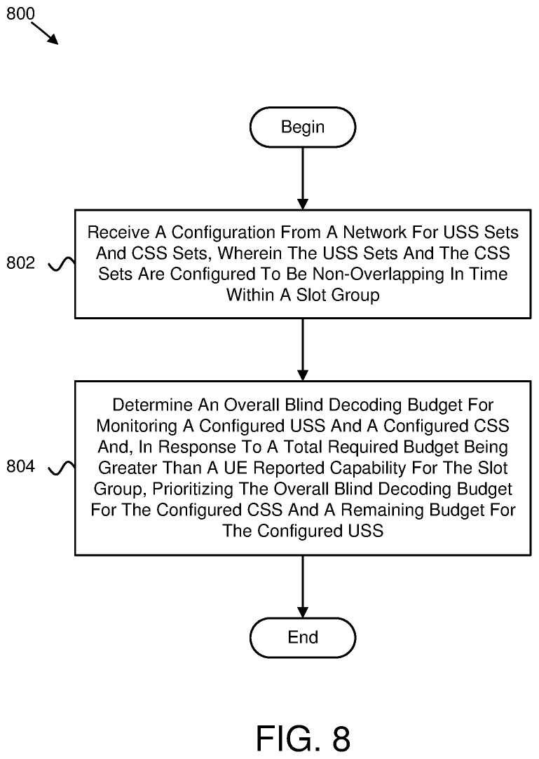

FIG. 8 is a flow chart diagram illustrating another embodiment of a method 800 for configuring a device based on multiple search space sets. In some embodiments, the method 800 is performed by an apparatus, such as the remote unit 102. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802 a configuration from a network for USS sets and CSS sets. The USS sets and the CSS sets are configured to be non-overlapping in time within a slot group. In some embodiments, the method 800 includes determining 804 an overall blind decoding budget for monitoring a configured USS and a configured CSS and, in response to a total required budget being greater than a UE reported capability for the slot group, prioritizing the overall blind decoding budget for the configured CSS and a remaining budget for the configured USS.

In certain embodiments, the configured USS is configured in earlier PDCCH monitoring occasions than the configured CSS in the slot group. In some embodiments, in response to the UE reported capability being maintain across different slot groups, a CSS preceding a USS in a previous slot group and another CSS following the USS in the same slot group are prioritized, and only the remaining budget is used for the USS. In various embodiments, in response to the remaining budget being sufficient for only some of the configured USS, the remaining budget is applied for USS starting with a lowest search space index.

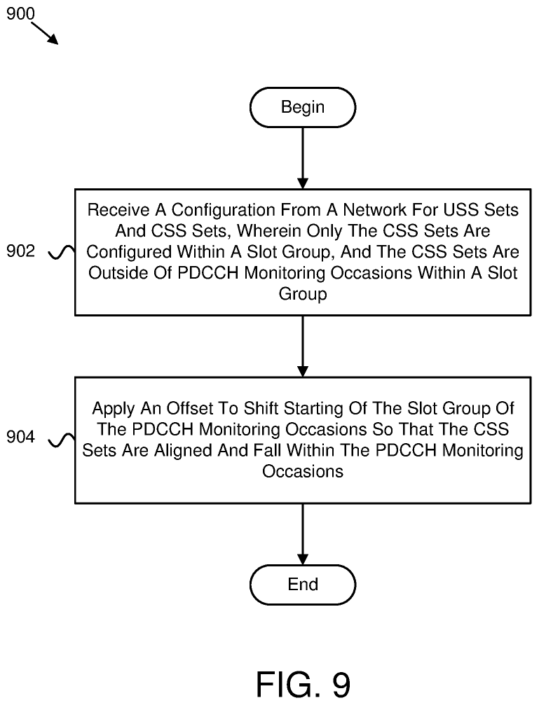

FIG. 9 is a flow chart diagram illustrating a further embodiment of a method 900 for configuring a device based on multiple search space sets. In some embodiments, the method 900 is performed by an apparatus, such as the remote unit 102. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes receiving 902 a configuration from a network for USS sets and CSS sets. Only the CSS sets are configured within a slot group, and the CSS sets are outside of PDCCH monitoring occasions within a slot group. In some embodiments, the method 900 includes applying 904 an offset to shift starting of the slot group of the PDCCH monitoring occasion so that the CSS sets are aligned and fall within the PDCCH monitoring occasions.

In certain embodiments, the shift starting is applied to slot groups following the slot group and corresponding PDCCH monitoring occasions so that a blind decoding budget is less than a UE reported capability. In some embodiments, the USS sets are monitored based on the offset to shift starting of the slot group.

In one embodiment, an apparatus comprises: a receiver to: receive a configuration from a network for USS sets and CSS sets; and receive control information associated with the CSS sets in the USS sets in response to the CSS sets being configured outside of monitoring occasions of the apparatus and the USS sets are configured within PDCCH monitoring occasions of the apparatus.

In certain embodiments, a search space configuration for PDCCH monitoring is configured for slots group, the PDCCH monitoring occasions within the slot groups are continuous across at least one slot, a minimum gap between multiple PDCCH monitoring occasions across multiple slot groups is greater than a UE reported capability, and, in response to a CSS being configured between two PDCCH monitoring occasions, not being required to monitor the CSS.

In some embodiments, a USS of the USS sets with a lowest index is replaced with at least one CSS configuration.

In some embodiments, the processor expects to drop the USS in response to the blind decoding budget being exceeded.

In various embodiments, the processor expects to drop low priority downlink control information (DCI) formats corresponding to the USS.

In certain embodiments, the processor expects to drop DCI formats of an uplink (UL) grant in response to there being no UL data to be transmitted by the UE.

In some embodiments, a priority may be assigned to the USS and the CSS to be able drop one with a least priority in response to the UE exceeding the blind decoding budget.

In various embodiments, the processor expects to prioritize monitoring of CSS within the PDCCH monitoring occasion using the USS budget.

In one embodiment, a method at a UE, the method comprises: receiving a configuration from a network for USS sets and CSS sets; and receiving control information associated with the CSS sets in the USS sets in response to the CSS sets being configured outside of monitoring occasions of the UE and the USS sets are configured within PDCCH monitoring occasions of the UE.

In certain embodiments, a search space configuration for PDCCH monitoring is configured for slots group, the PDCCH monitoring occasions within the slot groups are continuous across at least one slot, a minimum gap between multiple PDCCH monitoring occasions across multiple slot groups is greater than a UE reported capability, and, in response to a CSS being configured between two PDCCH monitoring occasions, not being required to monitor the CSS.

In some embodiments, a USS of the USS sets with a lowest index is replaced with at least one CSS configuration.

In some embodiments, the method further comprising expecting to drop the USS in response to the blind decoding budget being exceeded.

In various embodiments, the method further comprises expecting to drop low priority downlink control information (DCI) formats corresponding to the USS.

In certain embodiments, the method further comprises expecting to drop DCI formats of an uplink (UL) grant in response to there being no UL data to be transmitted by the UE.

In some embodiments, a priority may be assigned to the USS and the CSS to be able drop one with a least priority in response to the UE exceeding the blind decoding budget.

In various embodiments, the method further comprising expecting to prioritize monitoring of CSS within the PDCCH monitoring occasion using the USS budget.

In one embodiment, an apparatus comprises: a receiver to receive a configuration from a network for USS sets and CSS sets, wherein the USS sets and the CSS sets are configured to be non-overlapping in time within a slot group; and a processor to determine an overall blind decoding budget for monitoring a configured USS and a configured CSS and, in response to a total required budget being greater than a UE reported capability for the slot group, prioritize the overall blind decoding budget for the configured CSS and a remaining budget for the configured USS.

In certain embodiments, the configured USS is configured in earlier PDCCH monitoring occasions than the configured CSS in the slot group.

In some embodiments, in response to the UE reported capability being maintain across different slot groups, a CSS preceding a USS in a previous slot group and another CSS following the USS in the same slot group are prioritized, and only the remaining budget is used for the USS.

In various embodiments, in response to the remaining budget being sufficient for only some of the configured USS, the remaining budget is applied for USS starting with a lowest search space index.

In one embodiment, a method at a UE, the method comprises: receiving a configuration from a network for USS sets and CSS sets, wherein the USS sets and the CSS sets are configured to be non-overlapping in time within a slot group; and determining an overall blind decoding budget for monitoring a configured USS and a configured CSS and, in response to a total required budget being greater than a UE reported capability for the slot group, prioritizing the overall blind decoding budget for the configured CSS and a remaining budget for the configured USS.

In certain embodiments, the configured USS is configured in earlier PDCCH monitoring occasions than the configured CSS in the slot group.

In some embodiments, in response to the UE reported capability being maintain across different slot groups, a CSS preceding a USS in a previous slot group and another CSS following the USS in the same slot group are prioritized, and only the remaining budget is used for the USS

In various embodiments, in response to the remaining budget being sufficient for only some of the configured USS, the remaining budget is applied for USS starting with a lowest search space index.

In one embodiment, an apparatus comprises: a receiver to receive a configuration from a network for USS sets and CSS sets, wherein only the CSS sets are configured within a slot group, and the CSS sets are outside of PDCCH monitoring occasions within a slot group; and a processor to apply an offset to shift starting of the slot group of the PDCCH monitoring occasion so that the CSS sets are aligned and fall within the PDCCH monitoring occasions.

In certain embodiments, the shift starting is applied to slot groups following the slot group and corresponding PDCCH monitoring occasions so that a blind decoding budget is less than a UE reported capability.

In some embodiments, the USS sets are monitored based on the offset to shift starting of the slot group.

In one embodiment, a method at a UE, the method comprises: receiving a configuration from a network for USS sets and CSS sets, wherein only the CSS sets are configured within a slot group, and the CSS sets are outside of PDCCH monitoring occasions within a slot group; and applying an offset to shift starting of the slot group of the PDCCH monitoring occasion so that the CSS sets are aligned and fall within the PDCCH monitoring occasions.

In certain embodiments, the shift starting is applied to slot groups following the slot group and corresponding PDCCH monitoring occasions so that a blind decoding budget is less than a UE reported capability.

In some embodiments, the USS sets are monitored based on the offset to shift starting of the slot group.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a configuration from a network for user equipment (UE)-specific search space (USS) sets and common search space (CSS) sets; and
receive control information associated with the CSS sets in the USS sets in response to the CSS sets being configured outside of monitoring occasions of the UE and the USS sets are configured within physical downlink control channel (PDCCH) monitoring occasions of the UE.

2. The UE of claim 1, wherein a search space configuration for PDCCH monitoring is configured for slots group, the PDCCH monitoring occasions within the slot groups are continuous across at least one slot, a minimum gap between multiple PDCCH monitoring occasions across multiple slot groups is greater than a UE reported capability, and, in response to a CSS being configured between two PDCCH monitoring occasions, not being required to monitor the CSS.

3. The UE of claim 2, wherein a USS of the USS sets with a lowest index is replaced with at least one CSS configuration.

4. The UE of claim 2, wherein the at least one processor is configured to cause the UE to expect to drop the USS in response to a blind decoding budget being exceeded.

5. The UE of claim 4, wherein the at least one processor is configured to cause the UE to expect to drop low priority downlink control information (DCI) formats corresponding to the USS.

6. The UE of claim 4, wherein the at least one processor is configured to cause the UE to expect to drop DCI formats of an uplink (UL) grant in response to there being no UL data to be transmitted by the UE.

7. The UE of claim 4, wherein a priority may be assigned to the USS and the CSS to be able drop one with a least priority in response to the UE exceeding the blind decoding budget.

8. The UE of claim 1, wherein the at least one processor is configured to cause the UE to expect to prioritize monitoring of CSS within the PDCCH monitoring occasion using a USS budget.

9. A user equipment (UE), comprising:
at least one memory; and
at least one processor coupled with the at least one memory and configured to cause the UE to:
receive a configuration from a network for UE-specific search space (USS) sets and common search space (CSS) sets, wherein the USS sets and the CSS sets are configured to be non-overlapping in time within a slot group; and
determine an overall blind decoding budget for monitoring a configured USS and a configured CSS and, in response to a total required budget being greater than a UE reported capability for the slot group, prioritize the overall blind decoding budget for the configured CSS and a remaining budget for the configured USS.

10. The UE of claim 9, wherein the configured USS is configured in earlier physical downlink control channel (PDCCH) monitoring occasions than the configured CSS in the slot group.

11. The UE of claim 9, wherein, in response to the UE reported capability being maintain across different slot groups, a CSS preceding a USS in a previous slot group and another CSS following the USS in the same slot group are prioritized, and only the remaining budget is used for the USS.

12. The UE of claim 9, wherein, in response to the remaining budget being sufficient for only some of the configured USS, the remaining budget is applied for USS starting with a lowest search space index.

13. A user equipment (UE), comprising:
at least one memory; and
at least one processor coupled with the at least one memory and configured to cause the UE to:
receive a configuration from a network for UE-specific search space (USS) sets and common search space (CSS) sets, wherein only the CSS sets are configured within a slot group, and the CSS sets are outside of physical downlink control channel (PDCCH) monitoring occasions within a slot group; and
apply an offset to shift starting of the slot group of the PDCCH monitoring occasion so that the CSS sets are aligned and fall within the PDCCH monitoring occasions.

14. The UE of claim 13, wherein the shift starting is applied to slot groups following the slot group and corresponding PDCCH monitoring occasions so that a blind decoding budget is less than a UE reported capability.

15. The UE of claim 13, wherein the USS sets are monitored based on the offset to shift starting of the slot group.

16. A processor for wireless communication, comprising:
at least one controller coupled with at least one memory and configured to cause the processor to:
receive a configuration from a network for user equipment (UE)-specific search space (USS) sets and common search space (CSS) sets; and
receive control information associated with the CSS sets in the USS sets in response to the CSS sets being configured outside of monitoring occasions of the processor and the USS sets are configured within physical downlink control channel (PDCCH) monitoring occasions of the processor.

17. The processor of claim 16, wherein a search space configuration for PDCCH monitoring is configured for slots group, the PDCCH monitoring occasions within the slot groups are continuous across at least one slot, a minimum gap between multiple PDCCH monitoring occasions across multiple slot groups is greater than a UE reported capability, and, in response to a CSS being configured between two PDCCH monitoring occasions, not being required to monitor the CSS.

18. The processor of claim 17, wherein a USS of the USS sets with a lowest index is replaced with at least one CSS configuration.

19. The processor of claim 17, wherein the at least one controller is configured to cause the processor to expect to drop the USS in response to a blind decoding budget being exceeded.

20. The processor of claim 19, wherein the at least one controller is configured to cause the processor to expect to drop low priority downlink control information (DCI) formats corresponding to the USS.
